(19) United States
(12) Patent Application Publication
(10) Pub. No.: US 2021/0339762 A1
(43) Pub. Date: Nov. 4, 2021

(54) COMMUNICATION INTERFACE MODULE FOR AUTOMATED DRIVING AND INFORMATION PROCESSING METHOD FOR AUTOMATED DRIVING

(71) Applicant: TOYOTA JIDOSHA KABUSHIKI KAISHA, Aichi-ken (JP)

(72) Inventor: Sokfan YEE, Toyota-shi (JP)

(21) Appl. No.: 17/207,558

(22) Filed: Mar. 19, 2021

(30) Foreign Application Priority Data
May 1, 2020 (JP) 2020-081450

(51) Int. Cl. B60W 50/10; B60W 30/182; B60W 50/08; B60R 16/023

(52) U.S. Cl. CPC B60W 50/10; B60W 30/182; B60W 2520/105; B60R 16/0231; B60W 2510/20; B60W 50/085

(57) ABSTRACT

An information processing method for automated driving includes: a request determining step of receiving a vehicle control request from an autonomous driving kit and determining whether the vehicle control request is a first request of a trajectory type or a second request of a combined type of an acceleration and a steering amount; a first request transmitting step of transmitting a control signal corresponding to the first request to a control unit when it is determined that the vehicle control request is the first request; and a second request transmitting step of transmitting a control signal corresponding to the second request to the control unit when it is determined that the vehicle control request is the second request.

### CROSS-REFERENCE TO RELATED APPLICATION

This application claims priority to Japanese Patent Application No. 2020-081450 filed on May 1, 2020, incorporated herein by reference in its entirety.

### BACKGROUND

### 1. Technical Field

The disclosure relates to a communication interface module for automated driving and an information processing method for automated driving.

### 2. Description of Related Art

For example, an automated driving module described in Japanese Unexamined Patent Application Publication No. 2019-177837 (JP 2019-177837 A) is known. This publication discloses a vehicle including a control unit that performs automatic control of a steering angle, in which a command value of the steering angle which is output to the control unit is determined such that an amount of change of the steering angle per unit time is equal to or less than a predetermined upper limit value based on a target value of the steering angle when the target value of the steering angle is input thereto.

### SUMMARY

It is conceivable that an autonomous driving kit be connected to an automated driving device of an automated-driving vehicle and the automated-driving vehicle be made to travel in accordance with a vehicle control request from the autonomous driving kit. However, information for automated driving (for example, a trajectory) which is used for the automated-driving vehicle and the vehicle control request from the autonomous driving kit may not match, for example, in a representation mode of information (such as types of physical quantities). Accordingly, there is room for improvement in appropriately performing automated driving using the autonomous driving kit while curbing change of principal configurations for automated driving of the automated-driving vehicle.

Therefore, the disclosure provides a communication interface module for automated driving and an information processing method for automated driving that can appropriately perform automated driving using an autonomous driving kit while curbing change of principal configurations for automated driving of an automated-driving vehicle.

According to an aspect of the disclosure, there is provided a communication interface module for automated driving that transmits a control signal to a control unit configured to control a travel actuator of an automated-driving vehicle in response to a vehicle control request from an autonomous driving kit, the communication interface module for automated driving including: a request determining unit configured to receive the vehicle control request from the autonomous driving kit and to determine whether the vehicle control request is a first request of a trajectory type or a second request of a combined type of an acceleration and a steering amount; a first request transmitting unit configured to transmit a control signal corresponding to the first request to the control unit when the request determining unit determines that the vehicle control request is the first request; and a second request transmitting unit configured to transmit a control signal corresponding to the second request to the control unit when the request determining unit determines that the vehicle control request is the second request.

In the communication interface module for automated driving according to the aspect of the disclosure, the request determining unit receives the vehicle control request from the autonomous driving kit. The request determining unit determines whether the vehicle control request is the first request of a trajectory type or the second request of a combined type of an acceleration and a steering amount. When the request determining unit determines that the vehicle control request is the first request, the first request transmitting unit transmits the control signal corresponding to the first request to the control unit. Accordingly, the travel actuator is controlled with the control signal corresponding to the first request of a trajectory type. When the request determining unit determines that the vehicle control request is the second request, the second request transmitting unit transmits the control signal corresponding to the second request to the control unit. Accordingly, the travel actuator is controlled with the control signal corresponding to the second request of a combined type of an acceleration and a steering amount. By switching the control signal for the control unit depending on the type of the vehicle control request in this way, it is possible to perform automated driving of an automated-driving vehicle with the autonomous driving kit in which the vehicle control request is the first request of a trajectory type and the autonomous driving kit in which the vehicle control request is the second request of a combined type of an acceleration and a steering amount without changing principal configurations for automated driving of the automated-driving vehicle. Accordingly, with the communication interface module for automated driving, it is possible to appropriately perform automated driving using an autonomous driving kit while curbing change of principal configurations for automated driving of the automated-driving vehicle.

In an embodiment of the disclosure, the vehicle control request may include a data label indicating whether the vehicle control request is the first request or the second request, and the request determining unit may be configured to determine whether the vehicle control request is the first request or the second request based on the data label. In this case, the request determining unit can easily determine the type of the vehicle control request using the data label.

In an embodiment of the disclosure, the communication interface module for automated driving may further include a vehicle information integrating unit configured to receive a vehicle response associated with a response parameter of the automated-driving vehicle with respect to the vehicle control request from the automated-driving vehicle and to transmit a vehicle control response including the vehicle response to the autonomous driving kit. The vehicle information integrating unit may be configured to additionally receive a responsive range of the response parameter and a vehicle state of the automated-driving vehicle from the automated-driving vehicle and to integrate the received information into the vehicle control response. In this case, in addition to the vehicle response from the automated-driving vehicle, the responsive range of the response parameter and the vehicle state of the automated-driving vehicle are received by the vehicle information integrating unit. The vehicle information integrating unit integrates the vehicle response, the responsive range, and the vehicle state into the vehicle control response and transmits the vehicle control response to the autonomous driving kit. Accordingly, since the response of the automated-driving vehicle with respect to the vehicle control request is appropriately correlated with the responsive range and the vehicle state, it is possible to appropriately feed the vehicle control response back to the autonomous driving kit in comparison with a case in which the information pieces are irregularly transmitted to the autonomous driving kit.

In an embodiment of the disclosure, the vehicle state may include a vehicle abnormality state associated with an abnormality of the automated-driving vehicle, and the vehicle information integrating unit may be configured to transmit the responsive range associated with a type of the abnormality to the autonomous driving kit when the abnormality is recognized based on the vehicle abnormality state. In this case, since the responsive range associated with the abnormality type can be used in the autonomous driving kit, it is possible to perform automated driving control which is appropriately limited depending on the abnormality type.

According to another aspect of the disclosure, there is provided an information processing method for automated driving of transmitting a control signal to a control unit configured to control a travel actuator of an automated-driving vehicle in response to a vehicle control request from an autonomous driving kit, the information processing method for automated driving including: a request determining step of receiving the vehicle control request from the autonomous driving kit and determining whether the vehicle control request is a first request of a trajectory type or a second request of a combined type of an acceleration and a steering amount; a first request transmitting step of transmitting a control signal corresponding to the first request to the control unit when it is determined in the request determining step that the vehicle control request is the first request; and a second request transmitting step of transmitting a control signal corresponding to the second request to the control unit when it is determined in the request determining step that the vehicle control request is the second request.

In the information processing method for automated driving according to the aspect of the disclosure, the vehicle control request is received from the autonomous driving kit in the request determining step. In the request determining step, it is determined whether the vehicle control request is the first request of a trajectory type or the second request of a combined type of an acceleration and a steering amount. When it is determined in the request determining step that the vehicle control request is the first request, the control signal corresponding to the first request is transmitted to the control unit in the first request transmitting step. Accordingly, the travel actuator is controlled with the control signal corresponding to the first request of a trajectory type. When it is determined in the request determining step that the vehicle control request is the second request, the control signal corresponding to the second request is transmitted to the control unit in the second request transmitting step. Accordingly, the travel actuator is controlled with the control signal corresponding to the second request of a combined type of an acceleration and a steering amount. By switching the control signal for the control unit depending on the type of the vehicle control request in this way, it is possible to perform automated driving of an automated-driving vehicle with the autonomous driving kit in which the vehicle control request is the first request of a trajectory type and the autonomous driving kit in which the vehicle control request is the second request of a combined type of an acceleration and a steering amount without changing principal configurations for automated driving of the automated-driving vehicle. Accordingly, with the information processing method for automated driving, it is possible to appropriately perform automated driving using an autonomous driving kit while curbing change of principal configurations for automated driving of the automated-driving vehicle.

In an embodiment of the disclosure, the vehicle control request may include a data label indicating whether the vehicle control request is the first request or the second request, and the request determining step may include determining whether the vehicle control request is the first request or the second request based on the data label. In this case, the type of the vehicle control request can be easily determined using the data label in the request determining step.

In an embodiment of the disclosure, the information processing method for automated driving may further include a vehicle information integrating step of receiving a vehicle response associated with a response parameter of the automated-driving vehicle with respect to the vehicle control request from the automated-driving vehicle and transmitting a vehicle control response including the vehicle response to the autonomous driving kit. The vehicle information integrating step may include additionally receiving a responsive range of the response parameter and a vehicle state of the automated-driving vehicle from the automated-driving vehicle and integrating the received information into the vehicle control response. In this case, in addition to the vehicle response from the automated-driving vehicle, the responsive range of the response parameter and the vehicle state of the automated-driving vehicle are received in the vehicle information integrating step. In the vehicle information integrating step, the vehicle response, the responsive range, and the vehicle state are integrated into the vehicle control response and are transmitted to the autonomous driving kit. Accordingly, since the response of the automated-driving vehicle with respect to the vehicle control request is appropriately correlated with the responsive range and the vehicle state, it is possible to appropriately feed the vehicle control response back to the autonomous driving kit in comparison with a case in which the information pieces are irregularly transmitted to the autonomous driving kit.

In an embodiment of the disclosure, the vehicle state may include a vehicle abnormality state associated with an abnormality of the automated-driving vehicle, and the vehicle information integrating step may include transmitting the responsive range associated with a type of the abnormality to the autonomous driving kit when the abnormality is recognized based on the vehicle abnormality state. In this case, since the responsive range associated with the abnormality type can be used in the autonomous driving kit, it is possible to perform automated driving control which is appropriately limited depending on the abnormality type.

According to the aspects of the disclosure, it is possible to provide a communication interface module for automated driving and an information processing method for automated driving that can appropriately perform automated driving using an autonomous driving kit while curbing change of principal configurations for automated driving of an automated-driving vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating an automated-driving vehicle including a communication interface module for automated driving according to an embodiment;

FIG. 2 is a block diagram illustrating a configuration of an autonomous driving kit;

FIG. 3 is a block diagram illustrating a configuration of a communication interface ECU illustrated in FIG. 1;

FIG. 4 is a flowchart illustrating an example of a request transmitting process;

FIG. 5 is a flowchart illustrating an example of an information integrating process;

FIG is a flowchart illustrating a modified example of the request transmitting process; and

FIG. 7 is a flowchart illustrating another modified example of the request transmitting process.

### DETAILED DESCRIPTION OF EMBODIMENTS

Hereinafter, an embodiment of the disclosure will be described with reference to the accompanying drawings.

### Configuration of Automated-Driving Vehicle

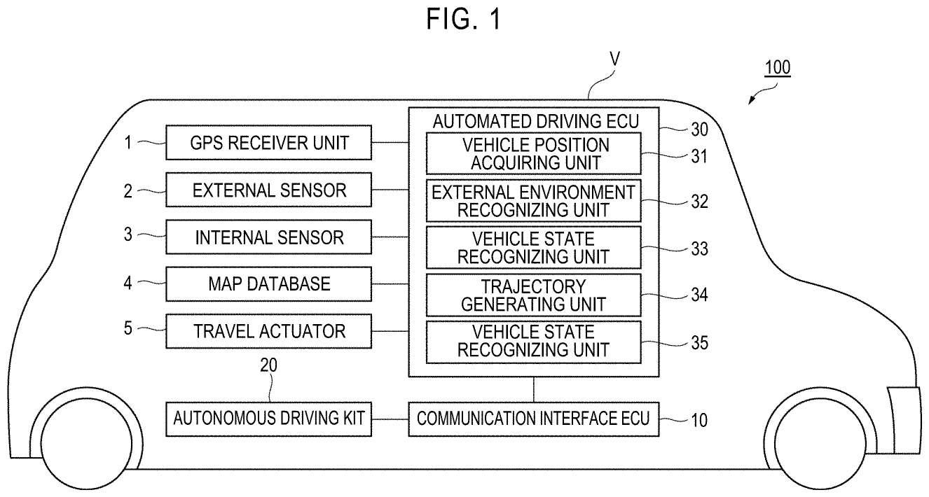

FIG. 1 is a block diagram illustrating an automated-driving vehicle including a communication interface module for automated driving according to an embodiment. As illustrated in FIG. 1, the automated-driving vehicle V includes a communication interface electronic control unit (ECU) 10, an autonomous driving kit 20, and an automated driving ECU (control unit) 30. The automated driving ECU 30 is an electronic control unit that is mounted in the automated-driving vehicle V and performs vehicle control of the automated-driving vehicle V.

The automated driving ECU 30 is configured to perform vehicle control including, for example, so-called conditional automated driving. The automated driving ECU 30 according to this embodiment is connected to the autonomous driving kit 20 via the communication interface ECU 10 (a communication interface module for automated driving), and can control a travel actuator 5 of the automated-driving vehicle V in response to a vehicle control request from the autonomous driving kit 20.

The vehicle control request is request information (interface information) on vehicle control of the automated-driving vehicle V which is transmitted from the autonomous driving kit 20 to the automated-driving vehicle V. The automated driving ECU 30 is configured to control the travel actuator 5 of the automated-driving vehicle V via the communication interface ECU 10 in response to the vehicle control request corresponding to a trajectory which is generated by the autonomous driving kit 20 in addition to a trajectory which is generated by the automated driving ECU 30.

The vehicle control includes driver-leading control and system-leading control. The driver-leading control is travel control with a driver driving the automated-driving vehicle V as a main subject. The driver-leading control may include, for example, driving support control, driver guidance control, and driver attention calling control. The driving support control is control for supporting traveling of a host vehicle with a driver's manual driving operation as initiative main subject. The driving support control may include automatic braking and lane keeping assist (LKA) and/or adaptive cruise control (ACC). The driving support control may include driving support control which is highly functional under specific conditions such as control for automatically overtaking a preceding vehicle which is slower than the host vehicle in an expressway or the like and/or control for automatically carrying out branching and merging in an expressway or the like. The driving support control may be control corresponding to so-called automated driving level 1 or automated driving level 2. An automated driving level is a level corresponding to a degree of automated driving which is defined in the Society of Automotive Engineers (SAE) J3016.

The system-leading control is automated driving control in which an automated driving system 100 causes the automated-driving vehicle V to travel autonomously as a main subject. The system-leading control may be automated driving control. The automated driving control is control for causing the automated-driving vehicle V to travel autonomously without a driver's driving operation. The system-leading control may be automated driving control corresponding to so-called conditional automated driving (automated driving level 3), fully automated driving under specific conditions (automated driving level 4), and fully automated driving (automated driving level 5). In the system-leading control, the automated driving system 100 controls acceleration, deceleration, and steering of a host vehicle.

The conditional automated driving means, for example, fully automated driving which can be performed under only predetermined conditions such as an expressway and is automated driving control in which the automated driving system 100 basically performs all driving tasks and a driver needs to appropriately take measures according to an intervention request for the driver from the automated driving system 100 or the like. The fully automated driving under specific conditions means, for example, fully automated driving which can be performed in only a predetermined region or the like and is automated driving control in which the automated driving system 100 performs all driving tasks. The fully automated driving is automated driving control in which the automated driving system 100 always performs all driving tasks while the fully automated driving is being performed.

Configuration of Automated Driving ECU

The automated driving ECU 30 includes a central processing unit (CPU), a read only memory (ROM), and a random access memory (RAM). In the automated driving ECU 30, various functions are realized, for example, by loading a program stored in the ROM into the RAM and causing the CPU to execute the program loaded into the RAM. The automated driving ECU 30 may be constituted by a plurality of electronic control units. The automated driving ECU 30 may be configured, for example, to perform the driver-leading control and the conditional automated driving of the system-leading control.

The automated driving ECU 30 is connected to a global positioning system (GPS) receiver unit 1, an external sensor 2, an internal sensor 3, a map database 4, and a travel actuator 5.

The GPS receiver unit 1 measures a position of the automated-driving vehicle V (for example, latitude and longitude of the automated-driving vehicle V) by receiving signals from three or more GPS satellites. The GPS receiver unit 1 transmits the measurement position information of the automated-driving vehicle V to the automated driving ECU 30.

The external sensor 2 is a detection device that detects an external environment of the automated-driving vehicle V. The external sensor 2 includes at least one of a camera and a radar sensor.

The camera is an imaging device that images the external environment of the automated-driving vehicle V. The camera is provided to the rear of a front windshield of the automated-driving vehicle V and captures a forward view. The camera transmits imaging information on the external environment of the automated-driving vehicle V to the automated driving ECU 30. The camera may be a monocular camera or may be a stereo camera.

The radar sensor is a detection device that detects an object near the automated-driving vehicle V using radio waves (for example, millimeter waves) or light. The radar sensor includes, for example, a millimeter wave radar or a LiDAR (Light Detection and Ranging) device. The radar sensor detects an object by transmitting radio waves or light to the surroundings of the automated-driving vehicle V and receiving radio waves or light reflected by the object. The radar sensor transmits the detected object information to the automated driving ECU 30. The object includes a mobile object such as a pedestrian, a bicycle, or another vehicle in addition to a fixed object such as a guard rail or a building.

The internal sensor 3 is a detection device that detects a state of the automated-driving vehicle V. The internal sensor 3 includes a vehicle speed sensor, an acceleration sensor, and a yaw rate sensor as sensors that detect a vehicle response and a vehicle state of the automated-driving vehicle V. The vehicle speed sensor is a detector that detects a speed of the automated-driving vehicle V. A wheel speed sensor that is provided in each wheel of the automated-driving vehicle V, a drive shaft rotating integrally with the wheel, or the like and detects a rotation speed of each wheel can be used as the vehicle speed sensor. The vehicle speed sensor transmits the detected vehicle speed information (wheel speed information) to the automated driving ECU 30.

The acceleration sensor is a detector that detects an acceleration of the automated-driving vehicle V. The acceleration sensor includes, for example, a longitudinal acceleration sensor that detects an acceleration in a longitudinal direction of the automated-driving vehicle V. The acceleration sensor may include a lateral acceleration sensor that detects a lateral acceleration of the automated-driving vehicle V. For example, the acceleration sensor transmits acceleration information of the automated-driving vehicle V to the automated driving ECU 30. The yaw rate sensor is a detector that detects a yaw rate around a vertical axis of the center of gravity (a rotational angular velocity) of the automated-driving vehicle V. For example, a gyro sensor can be used as the yaw rate sensor. The yaw rate sensor transmits the detected yaw rate information of the automated-driving vehicle V to the automated driving ECU 30.

The internal sensor 3 may include a steering sensor that detects a steering amount of a steering unit. The steering amount of the steering unit includes a steering angle. The steering amount of the steering unit may include a steering torque. The steering amount of the steering unit includes at least one of a steering amount which is generated by a driver's operation and a steering amount which is generated by operation of the travel actuator 5. The steering sensor transmits the detected steering amount information of the steering unit to the automated driving ECU 30.

The internal sensor 3 may include an accelerator pedal sensor. The accelerator pedal sensor is a sensor that detects a driver's operation of an accelerator pedal. The accelerator pedal sensor is provided in the accelerator pedal of the vehicle and detects an amount of operation of the accelerator pedal by a driver. The accelerator pedal sensor transmits the detected operation amount information of the accelerator pedal to the automated driving ECU 30.

The internal sensor 3 may include a brake oil pressure sensor that detects a brake pressure of a hydraulic brake system. The brake oil pressure sensor may be provided in each hydraulic system when the hydraulic brake system includes two or more hydraulic systems, and may detect the brake oil pressure of each hydraulic system. The brake oil pressure sensor transmits the detected brake oil pressure information to the automated driving ECU 30.

The map database 4 is a database that stores map information. The map database 4 is provided, for example, in a storage device such as an HDD which is mounted in the automated-driving vehicle V. The map information includes position information of roads, shape information of the roads (for example, curvature information), and position information of intersections and junctions. The map information may include traffic regulation information such as a speed limit correlated with the position information. The map information may include object information which is used to recognize a position on a map of the automated-driving vehicle V. The object may include lane markers, signals, guard rails, and road markers. The map database 4 may be provided in a server that can communicate with the automated-driving vehicle V. The storage device of the map database 4 is not limited to an HDD, and a solid state drive (SSD), an optical disc, a semiconductor memory, a flash memory, or the like may be used. It is assumed that the map database 4 stores map information with such accuracy that automated driving can be performed.

The travel actuator 5 is a device that is used to allow the automated-driving vehicle V to travel. The travel actuator 5 includes at least a drive actuator, a brake actuator, and a steering actuator. The drive actuator controls an amount of air supplied to an engine (a throttle opening) in accordance with a control signal from an autonomous driving kit ECU 40 and controls a driving force of the automated-driving vehicle V. When the automated-driving vehicle V is a hybrid vehicle, a control signal from the autonomous driving kit ECU 40 is input to a motor which is a power source to control the driving force in addition to the amount of air supplied to the engine. When the automated-driving vehicle V is an electric vehicle, a control signal from the autonomous driving kit ECU 40 is input to a motor which is a power source to control the driving force. The motor which is a power source in this case constitutes the travel actuator 5.

The brake actuator controls a brake system in accordance with a control signal from the autonomous driving kit ECU 40 and controls a braking force which is applied to the wheels of the automated-driving vehicle V. For example, a hydraulic brake system can be used as the brake system. The steering actuator controls operation of an assist motor that controls a steering torque in an electric power steering system in accordance with a control signal from the autonomous driving kit ECU 40. Accordingly, the steering actuator controls the steering torque of the automated-driving vehicle V. Functional configuration of automated driving ECU

A functional configuration of the automated driving ECU 30 will be described below. The automated driving ECU 30 includes a vehicle position acquiring unit 31, an external environment recognizing unit 32, a vehicle state recognizing unit 33, a trajectory generating unit 34, and an automated driving control unit 35. Some functions of the automated driving ECU 30 may be performed by a server that can communicate with the automated-driving vehicle V.

The vehicle position acquiring unit 31 acquires position information on a map of the automated-driving vehicle V based on the position information of the GPS receiver unit 1 and the map information of the map database 4. The vehicle position acquiring unit 31 may acquire the position information of the automated-driving vehicle V by a simultaneous localization and mapping (SLAM) technique using the object information included in the map information of the map database 4 and the detection result of the external sensor 2. The vehicle position acquiring unit 31 may recognize a lateral position of the automated-driving vehicle V relative to a lane (a position of the automated-driving vehicle V in a lane width direction) from a positional relationship between lane markers and the automated-driving vehicle V and add the recognized lateral position to the position information. The vehicle position acquiring unit 31 may acquire the position information on a map of the automated-driving vehicle V using known other techniques.

The external environment recognizing unit 32 recognizes the external environment of the automated-driving vehicle V based on the detection result from the external sensor 2. The external environment includes a position of a nearby object relative to the automated-driving vehicle V. The external environment may include a speed and a moving direction of a nearby object relative to the automated-driving vehicle V. The external environment may include a type of an object such as another vehicle, a pedestrian, or a bicycle. The type of an object can be identified by a known technique such as pattern matching. The external environment may include a result of recognition of lane markers (recognition of white lines) near the automated-driving vehicle V.

The vehicle state recognizing unit 33 recognizes a vehicle response and a vehicle state of the automated-driving vehicle V based on the detection result from the internal sensor 3. The vehicle response includes response parameters such as the vehicle speed, the acceleration, and the yaw rate of the automated-driving vehicle V, the steering amount of the steering unit, the amount of operation of the accelerator pedal, and the brake oil pressure of the hydraulic brake system. Specifically, the vehicle state recognizing unit 33 recognizes the vehicle speed of the automated-driving vehicle V based on the vehicle speed information from the vehicle speed sensor. The vehicle state recognizing unit 33 recognizes the acceleration of the automated-driving vehicle V based on the acceleration information from the acceleration sensor. The vehicle state recognizing unit 33 recognizes the direction of the automated-driving vehicle V based on the yaw rate information from the yaw rate sensor. The vehicle state recognizing unit 33 recognizes the steering amount of the steering unit of the automated-driving vehicle V based on the steering amount information from the steering sensor. The vehicle state recognizing unit 33 recognizes the operation amount information of the accelerator pedal based on the operation amount information from the accelerator pedal sensor. The vehicle state recognizing unit 33 recognizes the brake pressure of the hydraulic brake system of the automated-driving vehicle V based on the brake pressure information from the brake oil pressure sensor. The vehicle state recognizing unit 33 may recognize drive torque information based on the operation amount information from the accelerator pedal sensor, a detection result from a sensor incorporated in the drive actuator, or the like.

The vehicle state includes state parameters indicating whether the travel actuator 5 of the automated-driving vehicle V or the like is normal or abnormal (for example, flag information). The vehicle state includes a vehicle abnormality state associated with an abnormality of the automated-driving vehicle V. The vehicle abnormality state includes a state in which the hydraulic brake system of the automated-driving vehicle V is abnormal. The abnormality of the hydraulic brake system includes, for example, an abnormality in which the brake pressure does not increase to be equal to or greater than a predetermined failure pressure threshold value at the time of operation of the brake. The abnormality of the hydraulic brake system may be a state in which an abnormality of the brake pressure in at least one hydraulic system has been detected when the hydraulic brake system includes two or more hydraulic systems.

For example, when the hydraulic brake system includes two or more hydraulic systems and an abnormality of one hydraulic system is detected as the abnormality of the hydraulic brake system, the automated-driving vehicle V can decelerate using the hydraulic system in which an abnormality has not occurred. Accordingly, in this case, the vehicle state recognizing unit 33 sets a responsive range associated with the abnormality of the hydraulic brake system. The responsive range means a range of values which can be taken by the response parameter and a range which is defined by an upper limit value and a lower limit value of the vehicle response. The responsive range can be set to a range which is defined by an upper limit value and a lower limit value of the acceleration (deceleration) of the automated-driving vehicle V which can be realized by the brake pressure of the hydraulic system in which an abnormality has not been detected. The upper limit value and the lower limit value defining the responsive range may be stored in advance as predetermined fail-safe data (for example, integer values) associated with the abnormality of the hydraulic brake system.

The vehicle state may include a state in which a configuration with a redundant design using actuators important to the automated-driving vehicle, the ECUs, and the like is abnormal as the vehicle abnormality state. The vehicle state recognizing unit 33 may set the responsive range associated with an abnormality of such a configuration based on the fail-safe data which is stored in advance.

The trajectory generating unit 34 can generate a trajectory which is used for automated driving of the automated-driving vehicle V. When a vehicle control request is transmitted from the autonomous driving kit 20, the trajectory generating unit 34 in this embodiment handles a trajectory based on the vehicle control request as a generated trajectory. The case in which a vehicle control request is transmitted means a situation in which the autonomous driving kit 20 is connected to the automated driving ECU 30 via the communication interface ECU 10 and a vehicle control request is received from the autonomous driving kit 20.

When a vehicle control request is not transmitted from the autonomous driving kit 20, the trajectory generating unit 34 may generate a trajectory. The case in which a vehicle control request is not transmitted from the autonomous driving kit 20 includes a case in which the autonomous driving kit 20 is not connected or a case in which the autonomous driving kit 20 is connected to the automated driving ECU 30 via the communication interface ECU 10 and a vehicle control request is not received from the autonomous driving kit 20.

The trajectory includes a path in which the automated-driving vehicle V travels autonomously and a target vehicle speed in automated driving. The path is a trace in which the automated-driving vehicle V traveling autonomously is scheduled to travel on a travel route. The target vehicle speed is a target vehicle speed of the automated-driving vehicle V traveling autonomously on the travel route or data corresponding to the vehicle speed.

The travel route is a route in which the automated-driving vehicle V travels in automated driving. The travel route may be set by a known navigation system. A destination may be set by an occupant of the automated-driving vehicle V or may be automatically proposed by the autonomous driving kit 20, the navigation system, or the like. For example, when the autonomous driving kit 20 is connected to the automated driving ECU 30 via the communication interface ECU 10, information on the travel route is transmitted from the automated driving ECU 30 to the autonomous driving kit 20 and is used to generate a trajectory in the autonomous driving kit 20.

A representation mode of a trajectory includes, for example, a trajectory type and a combined type of an acceleration and a steering amount.

In a trajectory of the trajectory type, for example, a path can be represented by target lateral position data (a lateral position profile) of the automated-driving vehicle V based on a position on the travel route. The position on the travel route is, for example, a set longitudinal position which is set at predetermined intervals (for example, 1 m) in an extending direction of the travel route. The target lateral position is a target position in the width direction of a lane. In this case, the set longitudinal position and the target lateral position may be combined and set as positional coordinates. The lateral position profile corresponds to trace data which is represented by correlating a target lateral position with each set longitudinal position. In the trajectory of the trajectory type, a target vehicle speed can be represented, for example, by target yaw value data and target turning curvature data (a yaw curvature profile) for each set longitudinal position. The yaw curvature profile is data in which the target yaw value data and the target turning curvature data are correlated with each set longitudinal position.

In a trajectory of the combined type of an acceleration and a steering amount, for example, a path can be represented by target steering angle data of the automated-driving vehicle V (a steering amount profile) depending on the position on the travel route. The steering amount profile is data in which a target steering angle is correlated with each set longitudinal position. In the steering amount profile, a target steering torque instead of the target steering angle data may be correlated with each set longitudinal position. In the trajectory of the combined type of an acceleration and a steering amount, a target vehicle speed can be represented, for example, by target acceleration data for each set longitudinal position (an acceleration profile). The acceleration profile is data in which a target acceleration is correlated with each set longitudinal position.

The set longitudinal position may be set based on a traveling time of the automated-driving vehicle V instead of a distance. The set longitudinal position may be set to an arrival position of the automated-driving vehicle V after one second, an arrival position of the automated-driving vehicle V after two seconds, or the like.

For example, the trajectory generating unit 34 in this embodiment is configured to handle a trajectory of the combined type of an acceleration and a steering amount. When there is a first request of the trajectory type as the vehicle control request from the autonomous driving kit 20, the trajectory generating unit 34 handles information of a changed steering amount and a changed acceleration based on the first request in the communication interface ECU 10 as a trajectory of the combined type of an acceleration and a steering amount. When there is a second request of the combined type of an acceleration and a steering amount as the vehicle control request from the autonomous driving kit 20, the trajectory generating unit 34 handles information of a steering amount and an acceleration based on the second request as a trajectory of the combined type of an acceleration and a steering amount. Details of the first request, the second request, and the configurations and functions of the communication interface ECU 10 and the autonomous driving kit 20 will be described later.

For example, when there is no vehicle control request from the autonomous driving kit 20, the trajectory generating unit 34 may generate a trajectory of automated driving based on the travel route which is set by the automated-driving vehicle V, the map information of the map database 4, the position on a map of the automated-driving vehicle V acquired by the vehicle position acquiring unit 31, the external environment of the automated-driving vehicle V recognized by the external environment recognizing unit 32, and the vehicle response and the vehicle state of the automated-driving vehicle V recognized by the vehicle state recognizing unit 33. The trajectory generating unit 34 may generate a travel route of automated driving, for example, based on a destination, the map information, and the position on a map of the automated-driving vehicle V.

The automated driving control unit 35 performs automated driving of the automated-driving vehicle V based on the trajectory generated by the trajectory generating unit 34 or the vehicle control request handled as a trajectory by the trajectory generating unit 34. The automated driving control unit 35 performs automated driving of the automated-driving vehicle V using the automated driving ECU 30 by transmitting a control signal to the travel actuator 5, for example, based on the external environment of the automated-driving vehicle V recognized by the external environment recognizing unit 32, the vehicle response and the vehicle state of the automated-driving vehicle V acquired by the vehicle state recognizing unit 33, and the trajectory generated by the trajectory generating unit 34. Alternatively, the automated driving control unit 35 performs automated driving of the automated-driving vehicle V using the autonomous driving kit 20 by transmitting a control signal to the travel actuator 5 based on an external environment of the autonomous driving kit 20 recognized by an external environment recognizing unit 42 which will be described later, the vehicle response and the vehicle state of the automated-driving vehicle V acquired by the vehicle state recognizing unit 33, and the vehicle control request handled as a trajectory by the trajectory generating unit 34. Configuration of Autonomous Driving Kit

The autonomous driving kit (ADK) 20 is an electronic unit that generates a vehicle control request for the automated-driving vehicle V based on a travel route of automated driving to a destination generated by the automated-driving vehicle V side and a vehicle control response (which will be described later) which is a response from the automated-driving vehicle V and transmits the generated vehicle control request to the automated-driving vehicle V.

The autonomous driving kit 20 is configured separately from the automated-driving vehicle V and the automated driving ECU 30 and is configured to be connected to the automated driving ECU 30 via the communication interface ECU 10. The autonomous driving kit 20 is configured, for example, to perform the system-leading control (automated driving levels 3 to 5) as vehicle control. By transmitting a vehicle control request from the autonomous driving kit 20 to the automated driving ECU 30 via the communication interface ECU 10, the automated-driving vehicle V can be made to travel autonomously in accordance with vehicle control which can be performed by the autonomous driving kit 20.

The autonomous driving kit 20 may be developed by a developer other than developers of the automated-driving vehicle V and the automated driving ECU 30. For example, the developer can acquire control codes which are required to develop the autonomous driving kit 20 from an application program interface (API) published by a cloud service providing unit 50 and use the acquired control codes. The API refers to, for example, control codes such as functions which can be used for programming control mounted in the autonomous driving kit 20. However, since there is a certain degree of freedom in selecting variables of a function, information for automated driving (for example, a trajectory) which is used for the automated-driving vehicle V and a vehicle control request from the autonomous driving kit 20 may not match, for example, in a representation mode of information (such as types of physical quantities).

For example, the vehicle control request which is transmitted from the autonomous driving kit 20 may be one of a first request of a trajectory and a second request of a combined type of an acceleration and a steering amount. The first request is information on a trajectory request of the automated-driving vehicle V in which a trajectory is represented by the lateral position profile and a target vehicle speed is represented by the yaw curvature profile. The second request is information on the trajectory request of the automated-driving vehicle V in which a trajectory is represented by the steering amount profile and the target vehicle speed is represented by the acceleration profile.

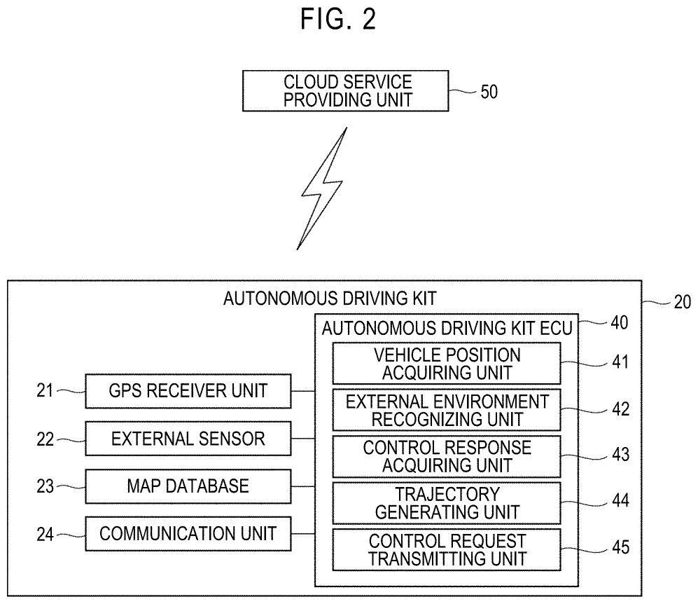

FIG. 2 is a block diagram illustrating the configuration of the autonomous driving kit. As illustrated in FIG. 2, the autonomous driving kit ECU 40 is an electronic control unit including, for example, a CPU, a ROM, and a RAM. The autonomous driving kit ECU 40 realizes various functions, for example, by loading a program stored in the ROM into the RAM and causing the CPU to execute the program loaded into the RAM. The autonomous driving kit ECU 40 may be constituted by a plurality of electronic control units.

The autonomous driving kit ECU 40 is connected to a GPS receiver unit 21, an external sensor 22, a map database 23, and a communication unit 24.

The GPS receiver unit 21 and the map database 23 employ the same configurations as the GPS receiver unit 1 and the map database 4 in the automated-driving vehicle V and thus detailed description thereof will be omitted. The external sensor 22 is configured such that the autonomous driving kit 20 can perform the system-leading control, and thus includes a LiDAR device as a radar sensor. The external sensor 22 may include a camera or may include a millimeter wave radar as the radar sensor.

The communication unit 24 includes a wired connection interface for wired connection to the communication interface ECU 10 of the automated-driving vehicle V. The wired connection between the communication unit 24 and the communication interface ECU 10 may employ, for example, a wired network such as an Ethernet (registered trademark) interface and a controller area network (CAN) communication circuit.

The communication unit 24 includes a communication device that performs communication via a wireless communication network. A network device, a network controller, a network card, or the like can be used for the communication unit 24. The communication unit 24 is configured, for example, to communicate with the cloud service providing unit 50 via the wired communication network. The communication unit 24 is used, for example, to perform collection of various types of data from the autonomous driving kit 20 to the cloud service providing unit 50 via the wireless communication network. In addition, the communication unit 24 is used to perform transmission of various types of data from the cloud service providing unit 50 to the autonomous driving kit 20 via the wireless communication network.

### Functional Configuration of Autonomous Driving Kit ECU

The functional configuration of the autonomous driving kit ECU 40 will be described below. The autonomous driving kit ECU 40 includes a vehicle position acquiring unit 41, an external environment recognizing unit 42, a control response acquiring unit 43, a trajectory generating unit 44, and a control request transmitting unit 45. Some functions of the autonomous driving kit ECU 40 which will be described below may be performed by a server (for example, the cloud service providing unit 50) that can communicate with the autonomous driving kit ECU 40.

The vehicle position acquiring unit 41 acquires position information on a map of the autonomous driving kit 20 mounted in the automated-driving vehicle V based on the position information of the GPS receiver unit 21 and the map information of the map database 23. The vehicle position acquiring unit 41 can employ the same configuration as the vehicle position acquiring unit 31 of the automated-driving vehicle V illustrated in FIG. 1, and thus detailed description thereof will be omitted.

The external environment recognizing unit 42 recognizes an external environment of the autonomous driving kit 20 mounted in the automated-driving vehicle V based on the detection result from the external sensor 22. The external environment recognizing unit 42 can employ the same configuration as the external environment recognizing unit 32 of the automated-driving vehicle V illustrated in FIG. 1, and thus detailed description thereof will be omitted.

The control response acquiring unit 43 acquires a response and a state associated with vehicle control of the automated-driving vehicle V which are transmitted from the automated-driving vehicle V to the autonomous driving kit 20 based on a vehicle control response which is received from the automated driving ECU 30 via the communication interface ECU 10. The vehicle control response is response information and state information (interface information) associated with the vehicle control of the automated-driving vehicle V which are transmitted from the automated-driving vehicle V to the autonomous driving kit 20. The response information refers to information on a control result of the automated-driving vehicle V which is a result of the vehicle control performed in response to the vehicle control request by the automated-driving vehicle V. The state information indicates a normal or abnormal state of the travel actuator 5 or the like of the automated-driving vehicle V and refers to information corresponding to the vehicle state.

The vehicle control response is used for the autonomous driving kit 20 to generate a new vehicle control request. The vehicle control response includes at least a vehicle response associated with a response parameter of the vehicle control of the automated-driving vehicle V. The vehicle control response may include a responsive range and a vehicle abnormality state based on the vehicle state of the automated-driving vehicle V including an abnormality of the automated-driving vehicle V when the abnormality is recognized.

The trajectory generating unit 44 generates a kit trajectory which is used for the automated driving ECU 30 to perform automated driving of the automated-driving vehicle V based on a travel route set on the automated driving ECU 30 side. The kit trajectory is a trajectory which is generated by the autonomous driving kit 20 to allow the automated-driving vehicle V to travel autonomously. The trajectory generating unit 44 generates the kit trajectory, for example, based on the travel route set on the automated driving ECU 30 side, the position information on a map of the autonomous driving kit 20 acquired by the vehicle position acquiring unit 41, the map information of the map database 23, the external environment of the autonomous driving kit 20 acquired by the external environment recognizing unit 42, and the vehicle control response acquired by the control response acquiring unit 43. The kit trajectory includes a kit path in which the automated-driving vehicle V travels by automated driving and a kit target vehicle speed in the automated driving.

The trajectory generating unit 44 generates a kit path. The kit path is a path which is generated by the autonomous driving kit 20 such that the automated-driving vehicle V travels autonomously. For example, the trajectory generating unit 44 generates the kit path such that the automated-driving vehicle V passes through the center of a lane (the center in a width direction of a lane) included in the travel route set on the automated driving ECU 30 side.

The trajectory generating unit 44 generates a kit target vehicle speed. The kit target vehicle speed is a target vehicle speed which is generated by the autonomous driving kit 20 such that the automated-driving vehicle V travels autonomously. The trajectory generating unit 44 generates the kit target vehicle speed, for example, based on speed-relevant information such as speed limit included in the map information of the map database 23 and the kit path. A set speed which is set in advance for a position or a section on a map may be used instead of the speed limit. The trajectory generating unit 44 generates the kit trajectory of automated driving from the kit path and the kit target vehicle speed. The method of generating the kit trajectory in the trajectory generating unit 44 is not limited to the above description.

The trajectory generating unit 44 generates the second request of a combined type of an acceleration and a steering amount as the vehicle control request. The trajectory generating unit 44 generates the kit trajectory of the vehicle control request in which the kit path is represented by the steering amount profile and the kit target vehicle speed is represented by the acceleration profile. The vehicle control request may include information for causing the automated-driving vehicle V to travel autonomously in addition to the kit trajectory.

The control request transmitting unit 45 transmits the vehicle control request generated by the trajectory generating unit 44 to the communication interface ECU 10. The control request transmitting unit 45 may transmit a data label indicating the first request or the second request to the communication interface ECU 10 in correlation with the vehicle control request. The data label is identification information which is added to identify whether the vehicle control request is the first request or the second request. For example, the data label may be a character string including alphanumeric characters which are different between the first request and the second request. The control request transmitting unit 45 transmits a data label DL2 indicating the second request to the communication interface ECU 10 in correlation with the vehicle control request.

The control request transmitting unit 45 may transmit the vehicle control request via different types of the wired connection interface (a communication mode) of the communication unit 24 depending on whether the vehicle control request is the first request or the second request. The type of the wired connection interface of the communication unit 24 via which the vehicle control request is transmitted may be determined in advance by design depending on whether the vehicle control request is the first request or the second request. For example, the vehicle control request which is the first request is transmitted using an Ethernet interface as the wired connection interface of the communication unit 24, and the vehicle control request which is the second request is transmitted using a CAN communication circuit as the wired connection interface of the communication unit 24.

### Configuration of Communication Interface ECU

The communication interface ECU 10 is, for example, an independent communication ECU which is disposed between the autonomous driving kit 20 and the automated driving ECU 30. The communication interface ECU 10 includes a communication interface module for automated driving. The communication interface module for automated driving is an electronic component module for causing the automated driving ECU 30 to perform automated driving of the automated-driving vehicle V in response to a vehicle control request from the autonomous driving kit 20.

The communication interface ECU 10 transmits a control signal to the automated driving control unit 35 in response to the vehicle control request from the autonomous driving kit 20 and causes the automated driving control unit 35 to control the travel actuator 5 of the automated-driving vehicle V. The communication interface ECU 10 is provided in the automated-driving vehicle V, for example, separately from the autonomous driving kit 20.

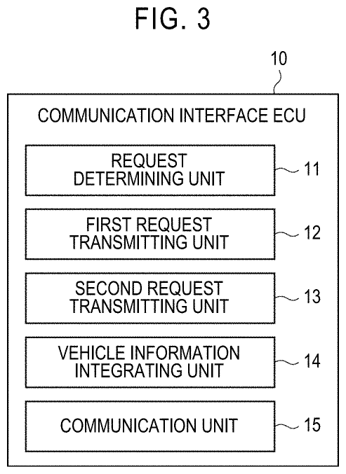

FIG. 3 is a block diagram illustrating the configuration of the communication interface ECU 10 illustrated in FIG. 1. As illustrated in FIG. 3, the communication interface ECU 10 includes, for example, a CPU, a ROM, and a RAM. The communication interface ECU 10 realizes various functions, for example, by loading a program stored in the ROM into the RAM and causing the CPU to execute the program loaded into the RAM. The communication interface ECU 10 may be constituted by a plurality of electronic control units.

### Functional Configuration of Communication Interface ECU

The functional configuration of the communication interface ECU 10 will be described below. The communication interface ECU 10 includes a request determining unit 11, a first request transmitting unit 12, a second request transmitting unit 13, a vehicle information integrating unit 14, and a communication unit 15.

The request determining unit 11 receives a vehicle control request from the autonomous driving kit 20. The request determining unit 11 recognizes, for example, a data label correlated with the received vehicle control request. The request determining unit 11 may recognize the type of the wired connection interface (a communication mode) which was used to transmit the received vehicle control request.

The request determining unit 11 determines whether the vehicle control request is the first request of a trajectory type or the second request of a combined type of an acceleration and a steering amount. The request determining unit 11 determines whether the vehicle control request is the first request or the second request, for example, based on the data label correlated with the received vehicle control request. The request determining unit 11 determines that the vehicle control request is the second request based on the data label DL2 correlated with the received vehicle control request.

When the request determining unit 11 determines that the vehicle control request is the first request, the first request transmitting unit 12 transmits a control signal corresponding to the first request to the automated driving ECU 30. When the request determining unit 11 determines that the vehicle control request is the second request, the second request transmitting unit 13 transmits a control signal corresponding to the second request to the automated driving ECU 30.

Here, as described above, the request determining unit 11 determines that the vehicle control request is the second request. Accordingly, the second request transmitting unit 13 transmits the control signal corresponding to the second request to the automated driving ECU 30. Specifically, since the vehicle control request from the autonomous driving kit 20 is the second request of a combined type of an acceleration and a steering amount which can be handled by the automated driving ECU 30, the second request transmitting unit 13 correlates a target steering amount and a target acceleration included in the kit path and the kit target vehicle speed with each set longitudinal position on the automated driving ECU 30 side. The second request transmitting unit 13 may not particularly convert the target steering amount and the target acceleration included in the kit path and the kit target vehicle speed to other physical quantity parameters. The second request transmitting unit 13 may limit the target steering amount and the target acceleration such that they are included in the responsive range. Information of the limited steering amount and the limited acceleration based on the second request is handled as a trajectory of a combined type of an acceleration and a steering amount by the trajectory generating unit 34 of the automated driving ECU 30.

The vehicle information integrating unit 14 receives a vehicle response associated with a response parameter of the automated-driving vehicle V with respect to the vehicle control request, a responsive range of the response parameter, and a vehicle state of the automated-driving vehicle V from the automated-driving vehicle V. The vehicle information integrating unit 14 transmits a vehicle control response including a vehicle response to the autonomous driving kit 20.

The vehicle information integrating unit 14 selects a vehicle response which is to be transmitted to the autonomous driving kit 20 to correspond to the profiles of the path and the target vehicle speed of the vehicle control request, for example, depending on whether the vehicle control request is the first request or the second request. For example, since the vehicle control request is the second request, the vehicle information integrating unit 14 selects a detected steering amount and a detected acceleration correlated with each set longitudinal position as the vehicle response which is to be transmitted to the autonomous driving kit 20 based on the recognition result (detection data) of the vehicle state recognizing unit 33 of the automated driving ECU 30. The vehicle information integrating unit 14 may not select a vehicle response which is not to be transmitted to the autonomous driving kit 20. For example, the vehicle information integrating unit 14 does not select (cuts off) operation amount information of the accelerator pedal sensor and drive torque information, and the like as the vehicle response which is not used in the autonomous driving kit 20.

When an abnormality of the automated-driving vehicle V is not recognized based on the vehicle abnormality state, the vehicle information integrating unit 14 does not integrate the vehicle state and the responsive range into the vehicle control response, but adds a vehicle response selected to be transmitted to the autonomous driving kit 20 to the vehicle control response and transmits the vehicle control response to the autonomous driving kit 20. In this case, the vehicle information integrating unit 14 transmits the vehicle control response including the selected vehicle response to the autonomous driving kit 20, for example, such that the vehicle control response is synchronized with a predetermined transmission cycle which is set in advance.

When an abnormality of the automated-driving vehicle V is recognized based on the vehicle abnormality state, the vehicle information integrating unit 14 transmits the responsive range associated with the type of the abnormality of the automated-driving vehicle V to the autonomous driving kit 20. When an abnormality of the automated-driving vehicle V is recognized based on the vehicle abnormality state, the vehicle information integrating unit 14 integrates the vehicle response, the vehicle state, and the responsive range associated with the type of the abnormality of the automated-driving vehicle V into the vehicle control response and transmits the vehicle control response to the autonomous driving kit 20. In this case, the vehicle information integrating unit 14 transmits the integrated vehicle control response to the autonomous driving kit 20, for example, such that the vehicle control response is synchronized with a predetermined transmission cycle which is set in advance.

The communication unit 15 includes wired connection interfaces for wired connection to the autonomous driving kit 20 and the automated driving ECU 30 of the automated-driving vehicle V. For example, a wired network such as an Ethernet interface or a CAN communication circuit can be used as the wired connection between the communication unit 15 and the communication interface ECU 10.

### Process of Communication Interface ECU

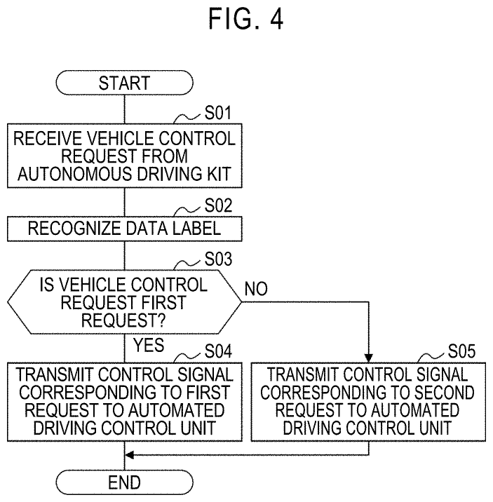

A process which is performed by the communication interface ECU 10 will be described below with reference to the drawings. The process of the communication interface ECU 10 constitutes an example of an information processing method for automated driving. FIG. 4 is a flowchart illustrating an example of a request transmitting process. The request transmitting process is performed by the communication interface ECU 10 when the automated-driving vehicle V is made to travel autonomously in response to the vehicle control request from the autonomous driving kit 20 in a state in which the autonomous driving kit 20 is connected to the automated driving ECU 30 via the communication interface ECU 10. The request transmitting process may be repeatedly performed, for example, at intervals of a predetermined process cycle which is set in advance.

As illustrated in FIG. 4, the information processing method for automated driving according to this embodiment includes a request determining step of S01, S02, and S03, a first request transmitting step of S04, and a second request transmitting step of S05. The request determining unit 11 of the communication interface ECU 10 receives a vehicle control request from the autonomous driving kit 20 in S01. In S01, for example, the request determining unit 11 receives the vehicle control request transmitted from the autonomous driving kit 20 via the communication unit 15. The request determining unit 11 of the communication interface ECU 10 recognizes a data label in S02. In S02, for example, the request determining unit 11 recognizes the data label correlated with the received vehicle control request.

In S03, the request determining unit 11 of the communication interface ECU 10 determines whether the vehicle control request is the first request. The request determining unit 11 determines whether the vehicle control request is the first request, for example, based on the data label recognized in S02. When it is determined that the vehicle control request is the first request (S03: YES), the communication interface ECU 10 causes the process flow to proceed to S04. When it is determined that the vehicle control request is not the first request (S03: NO), the communication interface ECU 10 causes the process flow to proceed to S05.

When it is determined that the vehicle control request is the first request (S03: YES), the first request transmitting unit 12 of the communication interface ECU 10 transmits a control signal corresponding to the first request to the automated driving ECU 30 in S04. On the other hand, when it is determined that the vehicle control request is not the first request (S03: NO), the first request transmitting unit 12 transmits a control signal corresponding to the second request to the automated driving ECU 30 in S05. Here, since the vehicle control request is the second request as described above, the request determining unit 11 determines that the vehicle control request is not the first request (S03: NO). Accordingly, the process of S05 is performed and the second request transmitting unit 13 transmits the control signal corresponding to the second request to the automated driving ECU 30. Thereafter, the communication interface ECU 10 ends this request transmitting process.

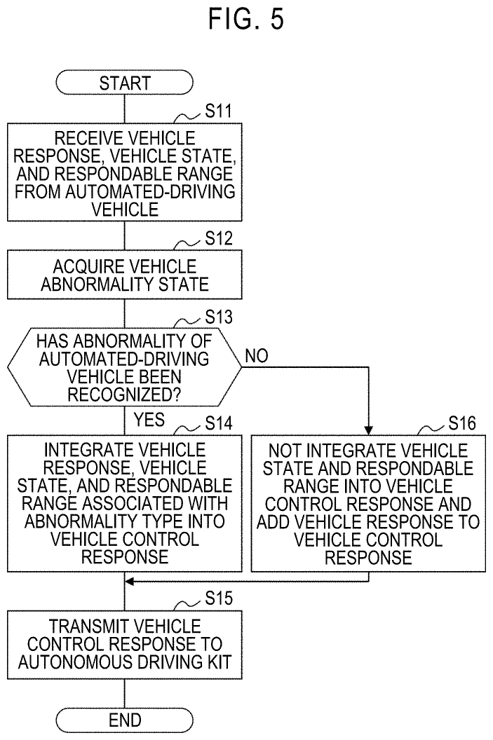

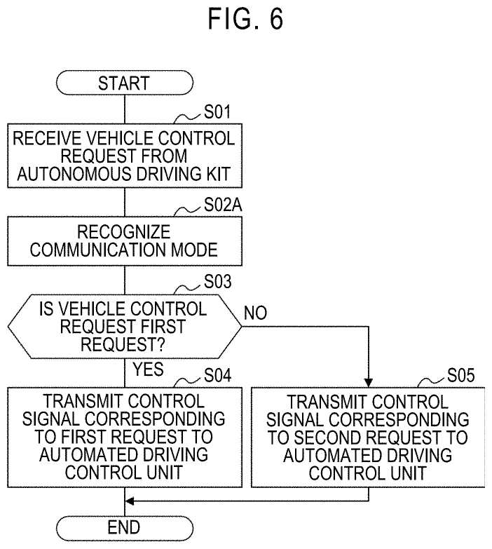

FIG. 5 is a flowchart illustrating an example of an information integrating process. The information integrating process is performed by the communication interface ECU 10 when the automated-driving vehicle V is traveling autonomously in response to a vehicle control request in a state in which the autonomous driving kit 20 is connected to the automated driving ECU 30 via the communication interface ECU 10. The information integrating process may be repeatedly performed, for example, in synchronization with the request transmitting process.

As illustrated in FIG. 5, the information processing method for automated driving according to this embodiment includes a vehicle information integrating step of S11, S12, S13, S14, S15, and S16. In S11, the vehicle information integrating unit 14 of the communication interface ECU 10 receives a vehicle response, a vehicle state, and a responsive range from the automated-driving vehicle V. In S11, the vehicle information integrating unit 14 receives the vehicle response, the vehicle state, and the responsive range transmitted from the automated driving ECU 30 via the communication unit 15 from the automated-driving vehicle V.

In S12, the vehicle information integrating unit 14 of the communication interface ECU 10 acquires a vehicle abnormality state. In S12, the vehicle information integrating unit 14 acquires the vehicle abnormality state from the vehicle state of the automated-driving vehicle V.

In S13, the vehicle information integrating unit 14 of the communication interface ECU 10 determines whether an abnormality of the automated-driving vehicle V has been recognized. The vehicle information integrating unit 14 determines whether an abnormality of the automated-driving vehicle V has been recognized, for example, based on the vehicle abnormality state recognized in S12. When it is determined that an abnormality of the automated-driving vehicle V has been recognized (S13: YES), the communication interface ECU 10 causes the process flow to proceed to S14. When it is determined that an abnormality of the automated-driving vehicle V has not been recognized (S13: NO), the communication interface ECU 10 causes the process flow to proceed to S16.

When it is determined that an abnormality of the automated-driving vehicle V has been recognized (S13: YES), the vehicle information integrating unit 14 of the communication interface ECU 10 integrates the vehicle response, the vehicle state, and the responsive range associated with the type of the abnormality of the automated-driving vehicle V into the vehicle control response in S14. In S15, the vehicle information integrating unit 14 of the communication interface ECU 10 transmits the integrated vehicle control response to the autonomous driving kit 20. Thereafter, the communication interface ECU 10 ends this request transmitting process.

On the other hand, when it is determined that an abnormality of the automated-driving vehicle V has not been recognized (S13: NO), the vehicle information integrating unit 14 of the communication interface ECU 10 does not integrate the vehicle state and the responsive range into the vehicle control response and adds the vehicle response selected to be transmitted to the autonomous driving kit 20 to the vehicle control response in S16. In S15, the vehicle information integrating unit 14 of the communication interface ECU 10 transmits the vehicle control response to the autonomous driving kit 20. Thereafter, the communication interface ECU 10 ends this request transmitting process.

### Operations and Advantages

In the aforementioned communication interface ECU 10, a vehicle control request from the autonomous driving kit 20 is received by the request determining unit 11. The request determining unit 11 determines whether the vehicle control request is the first request of a trajectory type or the second request of a combined type of an acceleration and a steering amount. When the request determining unit 11 determines that the vehicle control request is the first request, the first request transmitting unit 12 transmits a control signal corresponding to the first request to the automated driving control unit 35. Accordingly, the travel actuator 5 is controlled with the control signal corresponding to the first request of a trajectory type. When the request determining unit 11 determines that the vehicle control request is the second request, the second request transmitting unit 13 transmits a control signal corresponding to the second request to the automated driving control unit 35. Accordingly, the travel actuator 5 is controlled with the control signal corresponding to the second request of a combined type of an acceleration and a steering amount. By switching the control signal for the automated driving control unit 35 depending on the type of the vehicle control request in this way, it is possible to perform automated driving of the automated-driving vehicle V with the autonomous driving kit 20 in which the vehicle control request is the second request of a combined type of an acceleration and a steering amount without changing principal configurations for automated driving of the automated-driving vehicle V. Accordingly, with the communication interface ECU 10, it is possible to appropriately perform automated driving using an autonomous driving kit 20 while curbing change of principal configurations for automated driving of the automated-driving vehicle V.

The vehicle control request includes a data label indicating whether the vehicle control request is the first request or the second request, and the request determining unit 11 determines whether the vehicle control request is the first request or the second request based on the data label. Accordingly, the request determining unit 11 can easily determine the type of the vehicle control request using the data label.

The communication interface ECU 10 further includes the vehicle information integrating unit 14 that receives a vehicle response associated with a response parameter of the automated-driving vehicle V with respect to the vehicle control request from the automated-driving vehicle V and transmits a vehicle control response including the vehicle response to the autonomous driving kit 20. The vehicle information integrating unit 14 additionally receives a responsive range of the response parameter and the vehicle state of the automated-driving vehicle V from the automated-driving vehicle V and integrates the received information into the vehicle control response. Accordingly, in addition to the vehicle response from the automated-driving vehicle V, the responsive range of the response parameter and the vehicle state of the automated-driving vehicle V are received by the vehicle information integrating unit 14. The vehicle information integrating unit 14 integrates the vehicle response, the responsive range, and the vehicle state into the vehicle control response and transmits the vehicle control response to the autonomous driving kit 20. Accordingly, since the response of the automated-driving vehicle V with respect to the vehicle control request is appropriately correlated with the responsive range and the vehicle state, it is possible to appropriately feed the vehicle control response back to the autonomous driving kit 20 in comparison with a case in which the information pieces are irregularly transmitted to the autonomous driving kit 20.

The vehicle state includes a vehicle abnormality state associated with an abnormality of the automated-driving vehicle V, and the vehicle information integrating unit 14 transmits the responsive range associated with the type of the abnormality of the automated-driving vehicle V to the autonomous driving kit 20 when the abnormality of the automated-driving vehicle V is recognized based on the vehicle abnormality state. Accordingly, since the responsive range associated with the abnormality type of the automated-driving vehicle V can be used in the autonomous driving kit 20, it is possible to perform automated driving control which is appropriately limited depending on the abnormality type of the automated-driving vehicle V.

In the information processing method for automated driving according to the disclosure, the vehicle control request is received from the autonomous driving kit 20 in the request determining step. In the request determining step, it is determined whether the vehicle control request is the first request of a trajectory type or the second request of a combined type of an acceleration and a steering amount. When it is determined in the request determining step that the vehicle control request is the first request, the control signal corresponding to the first request is transmitted to the automated driving control unit 35 in the first request transmitting step. Accordingly, the travel actuator 5 is controlled with the control signal corresponding to the first request of a trajectory type. When it is determined in the request determining step that the vehicle control request is the second request, the control signal corresponding to the second request is transmitted to the automated driving control unit 35 in the second request transmitting step. Accordingly, the travel actuator 5 is controlled with the control signal corresponding to the second request of a combined type of an acceleration and a steering amount. By switching the control signal for the automated driving control unit 35 depending on the type of the vehicle control request in this way, it is possible to perform automated driving of the automated-driving vehicle V with the autonomous driving kit 20 in which the vehicle control request is the second request of a combined type of an acceleration and a steering amount without changing principal configurations for automated driving of the automated-driving vehicle V. Accordingly, with the information processing method for automated driving, it is possible to appropriately perform automated driving using an autonomous driving kit 20 while curbing change of principal configurations for automated driving of the automated-driving vehicle V.

The vehicle control request includes a data label indicating whether the vehicle control request is the first request or the second request, and the request determining step includes determining whether the vehicle control request is the first request or the second request based on the data label. In this case, the type of the vehicle control request can be easily determined using the data label in the request determining step.

The information processing method for automated driving further includes the vehicle information integrating step of receiving a vehicle response associated with a response parameter of the automated-driving vehicle V with respect to the vehicle control request from the automated-driving vehicle V and transmitting the vehicle control response including the vehicle response to the autonomous driving kit 20. The vehicle information integrating step includes additionally receiving a responsive range of the response parameter and a vehicle state of the automated-driving vehicle V from the automated-driving vehicle V and integrating the received information into the vehicle control response. Accordingly, in addition to the vehicle response from the automated-driving vehicle V, the responsive range of the response parameter and the vehicle state of the automated-driving vehicle V are received in the vehicle information integrating step. In the vehicle information integrating step, the vehicle response, the responsive range, and the vehicle state are integrated into the vehicle control response and are transmitted to the autonomous driving kit 20. Accordingly, since the response of the automated-driving vehicle V with respect to the vehicle control request is appropriately correlated with the responsive range and the vehicle state, it is possible to appropriately feed the vehicle control response back to the autonomous driving kit 20 in comparison with a case in which the information pieces are irregularly transmitted to the autonomous driving kit 20.

The vehicle state includes a vehicle abnormality state associated with an abnormality of the automated-driving vehicle V, and the vehicle information integrating step includes transmitting the responsive range associated with the type of the abnormality of the automated-driving vehicle V to the autonomous driving kit 20 when the abnormality is recognized based on the vehicle abnormality state. Accordingly, since the responsive range associated with the abnormality type can be used in the autonomous driving kit 20, it is possible to perform automated driving control which is appropriately limited depending on the abnormality type of the automated-driving vehicle V.

### Modified Examples

While an embodiment of the disclosure has been described above, the disclosure is not limited to the embodiment. The disclosure can be embodied in various forms by performing various modifications and improvements on the aforementioned embodiment based on knowledge of those skilled in the art.

In the aforementioned embodiment, the vehicle control request from the autonomous driving kit 20 is the second request of a combined type of an acceleration and a steering amount, but the vehicle control request from the autonomous driving kit 20 may be the first request of a trajectory type. For example, the trajectory generating unit 44 of the autonomous driving kit 20 generates the first request of a trajectory type as the vehicle control request. The trajectory generating unit 44 generates a kit trajectory of the vehicle control request as the first request in which the kit path is represented by the lateral position profile and the kit target vehicle speed is represented by the yaw curvature profile. The control request transmitting unit 45 of the autonomous driving kit 20 transmits a data label DL1 indicating the first request to the communication interface ECU 10 in correlation with the vehicle control request. The request determining unit 11 of the communication interface ECU 10 determines that the vehicle control request is the first request based on the data label DL1 correlated with the received vehicle control request. Since there is the first request of a trajectory type as the vehicle control request from the autonomous driving kit 20, the first request transmitting unit 12 of the communication interface ECU 10 converts a target lateral position, a target yaw value, and a target turning curvature included in the kit path and the kit target vehicle speed into a target steering amount and a target acceleration correlated with each set longitudinal position on the automated driving ECU 30 side such that a trajectory of a combined type of an acceleration and a steering amount which can be handled by the automated driving ECU 30 is acquired. The first request transmitting unit 12 may limit the converted target steering amount and the converted target acceleration such that they are included in the responsive range. The converted target steering amount and the converted target acceleration are transmitted to the automated driving ECU 30 via the communication unit 15. The converted target steering amount and the converted target acceleration corresponding to the first request are handled as a trajectory of a combined type of an acceleration and a steering amount in the trajectory generating unit 34 of the automated driving ECU 30. Regarding the vehicle response, since the vehicle control request is the first request, the vehicle information integrating unit 14 of the communication interface ECU 10 may select a detected lateral position, a detected yaw value, and a detected turning curvature correlated with each set longitudinal position as the vehicle response to be transmitted to the autonomous driving kit 20 based on the recognition result (detection data) from the vehicle state recognizing unit 33 of the automated driving ECU 30.

On the other hand, in the aforementioned embodiment, a trajectory which can be handled by the automated driving ECU 30 is a trajectory of a combined type of an acceleration and a steering amount, but may be a trajectory of a trajectory type. In this case, specifically, when there is the first request of a trajectory type which can be handled by the automated driving ECU 30 as the vehicle control request from the autonomous driving kit 20, the first request transmitting unit 12 may correlate a target lateral position, a target yaw value, and a target turning curvature included in the kit path and the kit target vehicle speed with each set longitudinal position on the automated driving ECU 30 side. The first request transmitting unit 12 may not particularly convert the target lateral position, the target yaw value, and the target turning curvature included in the kit path and the kit target vehicle speed into other physical quantity parameters. The first request transmitting unit 12 may limit the target lateral position, the target yaw value, and the target turning curvature such that they are included in the responsive range. Alternatively, when there is the second request of a combined type of an acceleration and a steering amount as the vehicle control request from the autonomous driving kit 20, the second request transmitting unit 13 may convert the target steering amount and the target acceleration included in the kit path and the kit target vehicle speed into the target lateral position, the target yaw value, and the target turning curvature correlated with each set longitudinal position such that the trajectory of a trajectory type which can be handled by the automated driving ECU 30 is acquired. The second request transmitting unit 13 may limit the converted target steering amount and the converted target acceleration such that they are included in the responsive range.

As described above in the modified examples, even when the trajectory which can be handled by the automated driving ECU 30 is any of the trajectory of a trajectory type and the trajectory of a combined type of an acceleration and a steering amount, the communication interface ECU 10 can cope with a case in which the vehicle control request from the autonomous driving kit 20 is the first request or a case in which the vehicle control request is the second request. More specifically, the first request transmitting unit 12 transmits the control signal corresponding to the first request to the automated driving ECU 30 when the request determining unit 11 determines that the vehicle control request is the first request, and the second request transmitting unit 13 transmits the control signal corresponding to the second request to the automated driving ECU 30 when the request determining unit 11 determines that the vehicle control request is the second request. Accordingly, even when the trajectory which can be handled by the automated driving ECU 30 is any type, the control signal for the automated driving control unit 35 can be appropriately switched depending on the type of the vehicle control request. Accordingly, it is possible to perform automated driving of the automated-driving vehicle V with the autonomous driving kit in which the vehicle control request is the first request of a trajectory type without changing principal configurations for automated driving of the automated-driving vehicle V. Accordingly, with the communication interface ECU 10, it is possible to appropriately perform automated driving using the autonomous driving kit 20 while curbing change of the principal configurations for automated driving of the automated-driving vehicle V. As a result, it is possible to adapt autonomous driving kits 20 of many developers to an automated-driving vehicle V and to enhance versatility of the automated-driving vehicle V.

In the aforementioned embodiment and the modified examples, the request determining unit 11 determines whether the vehicle control request is the first request or the second request based on the data label, but the disclosure is not limited thereto. For example, the request determining unit 11 may determine whether the vehicle control request is the first request or the second request based on the type of the wired connection interface (the communication mode) which was used to transmit the received vehicle control request. FIG. 6 is a flowchart illustrating a modified example of the request transmitting process. The flowchart illustrated in FIG. 6 is different from the flowchart illustrated in FIG. 4, in that S02 in FIG. 4 is replaced with the process of S02A. As illustrated in FIG. 6, an information processing method for automated driving according to a first modified example includes a request determining step of S02A. The request determining unit 11 of the communication interface ECU 10 may recognize the communication mode in S02A. In S02A, the request determining unit 11 may determine that the vehicle control request is the first request, for example, based on the fact that the wired connection interface of the communication unit 24 used to transmit the received vehicle control request is an Ethernet interface. The request determining unit 11 may determine that the vehicle control request is the second request (that the vehicle control request is not the first request) based on the fact that the wired connection interface of the communication unit 24 used to transmit the received vehicle control request is a CAN communication circuit. The request determining unit 11 can recognize the type of the wired connection interface of the communication unit 24 using a known technique.

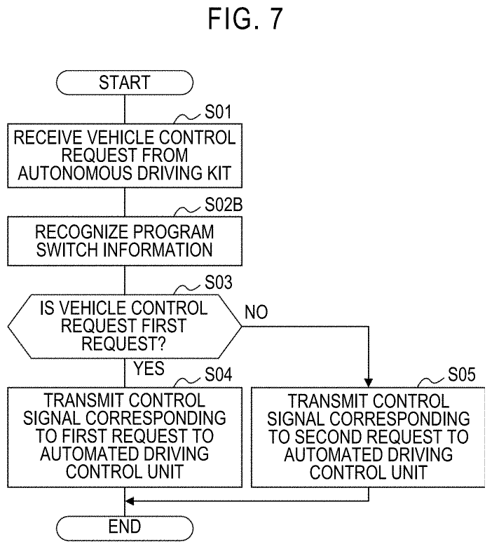

Alternatively, the request determining unit 11 may determine whether the vehicle control request is the first request or the second request, for example, based on program switch (compile SW) information for identifying whether the vehicle control request is the first request or the second request. For example, the request determining unit 11 may store a value of the program switch information indicating whether the vehicle control request is the first request or the second request in advance. The request determining unit 11 may determine that the vehicle control request is the first request, for example, when the value of the program switch information is “0 (that is, other than 1).” The request determining unit 11 may determine that the vehicle control request is the second request, for example, when the value of the program switch information is “1.” FIG. 7 is a flowchart illustrating another modified example of the request transmitting process. The flowchart illustrated in FIG. 7 is different from the flowchart illustrated in FIG. 4, in that S02 in FIG. 4 is replaced with the process of S02B. As illustrated in FIG. 7, the information processing method for automated driving according to a second modified example includes a request determining step of S02B. The request determining unit 11 of the communication interface ECU 10 may recognize program switch information in S02B. In S02B, the request determining unit 11 may determine that the vehicle control request is the first request, for example, based on the fact that the value of the program switch information is “0.” The request determining unit 11 may determine that the vehicle control request is the second request (that the vehicle control request is not the first request) based on the fact that the value of the program switching information is “1.” A physical switch (for example, a deep switch) may be used instead of the program switch (a compile SW) in software.

The request determining unit 11 may determine whether the vehicle control request is the first request or the second request based on the information other than the data label, the type of the wired connection interface (the communication mode), and the program switch (compile SW) information.

In the aforementioned embodiment and the modified examples, the vehicle information integrating unit 14 integrates the responsive range and the vehicle abnormality state into the vehicle control response depending on an abnormality of the automated-driving vehicle V when the abnormality of the automated-driving vehicle V has been recognized, but may normally integrate the responsive range and the vehicle abnormality state into the vehicle control response even when an abnormality of the automated-driving vehicle V has not been recognized. The vehicle information integrating unit 14 integrates the vehicle response, the responsive range, and the vehicle state into the vehicle control response, but may not integrate the information into the vehicle control response. Alternatively, the communication interface ECU 10 may not include the vehicle information integrating unit 14.

In the aforementioned embodiment and the modified examples, the autonomous driving kit 20 is configured to perform the system-leading control (automated driving levels 3 to 5) as vehicle control, but may be configured to perform automated driving levels 3 and 4 of the system-leading control or may be configured to perform automated driving level 3 of the system-leading control. The automated driving ECU 30 is configured, for example, to perform vehicle control including so-called conditional automated driving (automated driving level 3), but may be configured to perform driving support control (automated driving level 1 or automated driving level 2).

In the embodiment and the modified examples, the communication unit 15 of the communication interface ECU 10 is connected to the autonomous driving kit 20 and the automated driving ECU 30 of the automated-driving vehicle V in a wired manner, but may be connected to the autonomous driving kit 20 and the automated driving ECU 30 of the automated-driving vehicle V in a wireless manner.

In the embodiment and the modified examples, the communication interface module for automated driving is included in the communication interface ECU 10 for independent communication which is interposed between the autonomous driving kit 20 and the automated driving ECU 30, but the communication interface module for automated driving may be an electronic component module that is incorporated in the automated driving ECU 30 and mounted on a substrate.

The embodiment and the modified examples may be combined with each other according to required purposes and advantages.

What is claimed is:

1. A communication interface module for automated driving that transmits a control signal to a control unit configured to control a travel actuator of an automated-driving vehicle in response to a vehicle control request from an autonomous driving kit, the communication interface module for automated driving comprising:
a request determining unit configured to receive the vehicle control request from the autonomous driving kit and to determine whether the vehicle control request is a first request of a trajectory type or a second request of a combined type of an acceleration and a steering amount;
a first request transmitting unit configured to transmit a control signal corresponding to the first request to the control unit when the request determining unit determines that the vehicle control request is the first request; and
a second request transmitting unit configured to transmit a control signal corresponding to the second request to the control unit when the request determining unit determines that the vehicle control request is the second request.

2. The communication interface module for automated driving according to claim 1, wherein the vehicle control request includes a data label indicating whether the vehicle control request is the first request or the second request, and
wherein the request determining unit is configured to determine whether the vehicle control request is the first request or the second request based on the data label.

3. The communication interface module for automated driving according to claim 1, further comprising a vehicle information integrating unit configured to receive a vehicle response associated with a response parameter of the automated-driving vehicle with respect to the vehicle control request from the automated-driving vehicle and to transmit a vehicle control response including the vehicle response to the autonomous driving kit,
wherein the vehicle information integrating unit is configured to additionally receive a responsive range of the response parameter and a vehicle state of the automated-driving vehicle from the automated-driving vehicle and to integrate the received information into the vehicle control response.

4. The communication interface module for automated driving according to claim 3, wherein the vehicle state includes a vehicle abnormality state associated with an abnormality of the automated-driving vehicle, and
wherein the vehicle information integrating unit is configured to transmit the responsive range associated with a type of the abnormality to the autonomous driving kit when the abnormality is recognized based on the vehicle abnormality state.

5. An information processing method for automated driving of transmitting a control signal to a control unit configured to control a travel actuator of an automated-driving vehicle in response to a vehicle control request from an autonomous driving kit, the information processing method for automated driving comprising:
a request determining step of receiving the vehicle control request from the autonomous driving kit and determining whether the vehicle control request is a first request of a trajectory type or a second request of a combined type of an acceleration and a steering amount;
a first request transmitting step of transmitting a control signal corresponding to the first request to the control unit when it is determined in the request determining step that the vehicle control request is the first request; and
a second request transmitting step of transmitting a control signal corresponding to the second request to the control unit when it is determined in the request determining step that the vehicle control request is the second request.

6. The information processing method for automated driving according to claim 5, wherein the vehicle control request includes a data label indicating whether the vehicle control request is the first request or the second request, and
wherein the request determining step includes determining whether the vehicle control request is the first request or the second request based on the data label.

7. The information processing method for automated driving according to claim 5, further comprising a vehicle information integrating step of receiving a vehicle response associated with a response parameter of the automated-driving vehicle with respect to the vehicle control request from the automated-driving vehicle and transmitting a vehicle control response including the vehicle response to the autonomous driving kit,
wherein the vehicle information integrating step includes additionally receiving a responsive range of the response parameter and a vehicle state of the automated-driving vehicle from the automated-driving vehicle and integrating the received information into the vehicle control response.

8. The information processing method for automated driving according to claim 7, wherein the vehicle state includes a vehicle abnormality state associated with an abnormality of the automated-driving vehicle, and
wherein the vehicle information integrating step includes transmitting the responsive range associated with a type of the abnormality to the autonomous driving kit when the abnormality is recognized based on the vehicle abnormality state.
